(19) United States
(12) Patent Application Publication
(10) Pub. No.: US 2026/0160572 A1
(43) Pub. Date: Jun. 11, 2026

(54) Systems And Methods For Processing Data Broadcasted From Broadcasters

(71) Applicant: Google LLC, Mountain View, CA (US)

(72) Inventors: Peter T. Liu, Sunnyvale, CA (US); Chi Kin Benjamin Leung, Sunnyvale, CA (US); Punyabrata Ray, San Jose, CA (US)

(21) Appl. No.: 19/408,711

(22) Filed: Dec. 4, 2025

Related U.S. Application Data
(60) Provisional application No. 63/730,743, filed on Dec. 11, 2024.

(51) Int. Cl. G01C 21/36; H04W 4/024; H04W 4/06; H04W 4/42

(52) U.S. Cl. CPC G01C 21/3629; H04W 4/024; H04W 4/06; H04W 4/42

(57) ABSTRACT

Methods, systems, and apparatus, including computer-readable storage media for navigating users to desired destinations using navigation data broadcasted from locations at or near mass transit systems. While navigation software relies on up-to-date navigation information received over wireless networks, such as cellular networks, long-range wireless communication, and/or satellite systems, for guiding a user to a requested destination, these approaches become less reliable or unavailable along many routes using mass transit, such as underground subways, train stations in remote locations, and so on. The navigation system includes broadcasters configured to broadcast navigation data to user computing devices, which the devices can receive to display, output, or update instructions or information related to a navigation route, even when other forms of communication are not available.

### CROSS-REFERENCE TO RELATED APPLICATIONS

This application claims the benefit of the filing date of U.S. Provisional Patent Application No. 63/730,743 filed Dec. 11, 2024, the disclosure of which is hereby incorporated herein by reference.

### BACKGROUND

Navigation systems providing instructions for navigating to a destination often rely on satellite navigation systems, such as GPS, or other forms of wireless communication, e.g., cellular connections or Wi-Fi® connections, to accurately pinpoint the location of a computing device communicating with the system for navigating to a destination. Common forms of transportation, whether by mass transit, personal vehicle, or walking, can pass through underground tunnels or other locations where satellite navigation becomes less reliable or impossible, or the user may be inside a vehicle for an extended period of time where reception of external signals may be degraded and dead-reckoning is no longer accurate. When routes provided by a navigation system include mass transportation, such as by train, subway, or bus, lag and momentary errors in accurate determination of geolocation by a computing device can lead to the system not providing the correct notification to the device when it is time to get on or off certain stops. Placing additional broadcasters or relays to improve long-form communication systems, such as satellite, cellular, or Wi-Fi® is costly and not guaranteed to compensate for the lags and momentary errors.

Information relevant to navigating mass transit systems is often announced through public announcement speakers. Often, these announcements are repetitive, cover multiple routes, and/or are intentionally generic to be relevant to more users and increase the likelihood that users hear announcements that may affect their travel plans. Additionally, other sources of sound, such as other unrelated announcements, tunnel echoes, talking, or the sound of trains or other vehicles passing by, make it less likely that an announcement will be clearly heard and understood by those who stand to benefit from hearing the information in the announcement.

In addition to mass transit systems, other locations or points of interest typically provide announcements through speakers. These announcements are often irrelevant to a given user. The announcements that are relevant are typically difficult to identify and/or hear.

### BRIEF SUMMARY

Aspects of the disclosure relate to the use of broadcast data, such as audio streams and/or data packets transmitted via broadcasters, by a navigation system for navigating users to desired destinations. The broadcaster may, in some examples, be a transmitter, broadcaster, or the like. The broadcaster can be used to send, or broadcast, data, e.g. “broadcast data,” which can include data packets and/or audio streams. Broadcasters that are audio broadcasters can also be used to broadcast data for navigational purposes.

The broadcast data may be, at least partially, broadcasted from broadcasters located at, within, or otherwise near a mass transit system. Broadcast data can include, for example, data that can be used for computing navigation and/or determining one or more navigational routes (for clarity purposes, any data that can be used to compute navigation and/or determine navigational routes may be referred to as “navigation data”). Navigation software typically relies on up-to-date navigation information received from map servers over wireless networks, such as cellular networks, Wi-Fi® wireless connections, and/or satellite systems, to guide users to requested destinations. These approaches, however, become less reliable or unavailable along many routes in mass transit, such as underground subways, train stations in remote locations, and so on. In addition to the navigation information received from map servers, the navigation software typically relies on the location of the user computing device, which may be determined based on one or more location sensors of the user computing device. The location sensors may include, for example, global positioning system (GPS) sensors, Bluetooth transmitters, signals from a location provider, or the like. In contrast, the systems and methods described herein can use the broadcasters to determine a location of the user computing device, without having to rely on data from location sensors.

To ensure reliability and/or availability of up-to-date navigation information, which may include navigation instructions, the navigation systems described herein rely on audio streams and/or data packets transmitted by the broadcasters. The broadcasters may also be configured to broadcast data, e.g., navigation data, to user computing devices. The user computing devices can receive the broadcast data and display, output, or update instructions or information related to a navigation route, even when other forms of communication are not available. Audio and other types of data can be provided from the broadcasters directly to computing devices and user peripherals, such as headphones, headsets, earbuds, and so on, for improving the likelihood that users hear safety or navigation announcements affecting their travels along the navigation route.

The broadcasters can be configured to broadcast audio streams. The audio streams may be received by user peripheral devices and subsequently output such that the corresponding audio is output to users via the user peripheral devices. However, as disclosed herein, the audio streams can, additionally, be broadcast to user computing devices. The user computing devices may be configured to process the audio streams and provide, for output, a transcription of the audio streams, notifications related to user activities, notifications related to the audio streams, the audio associated with audio stream, or the like.

The broadcasters can leverage short-form communication technologies, such as communications protocols that implement the Bluetooth® standard. The broadcasters can be specific to different vehicles, e.g., respective broadcasters for different trains, buses, planes, or other vehicles that a mass transit system may use. Unlike other forms of wireless communication, the broadcasters can be configured for short range data transmission, e.g., over several meters or more, and use less power overall than other forms of communication. Broadcasting broadcasters, as described herein, may require less power and are generally of a smaller physical size relative to other types of transmission devices, such as for Wi-Fi® or cellular connections. Moreover, as the broadcasters are coupled to user computing devices and/or peripheral devices via Bluetooth®, which are broadly available, widely implemented, and have a common audio standard, the systems and methods discussed above and herein are easily deployed.

Broadcasting broadcasters can also be specific to different locations. For transit purposes, the broadcasters can be specific to different platforms, stations, terminals, depots, and other physical transit locations, such as train stations, subway stations, platforms, docks, terminals, and predetermined locations in which a vehicle, e.g., a train, bus, subway, etc., stops along a transit route, in which users of the navigation system may embark on or disembark from vehicles. Navigation software can use the known locations of these broadcasters to determine the user's location. Navigation software can also filter incoming navigation data from the broadcasters to process only data relevant for a current route which the user has set.

For general purposes, the broadcasters can be specific to different points of interest, such as restaurants, airports, airport terminals, museums, movie theaters, specific theaters within the movie theater, shopping centers, stores, etc.

Implementations of the present technology can each include, but are not limited to, the following. The features may be alone or in combination with one or more other features described herein.

One implementation of the technology is generally directed to a method, comprising identifying, by one or more processors, one or more instructions for a navigation route to a destination, determining, by the one or more processors, a current instruction of the one or more instructions to disembark from or embark on a vehicle, receiving, by the one or more processors, navigation data from one or more data broadcasters located inside, at, or near the vehicle, updating, by the one or more processors, at least the current instruction of the one or more instructions based on the received navigation data, and providing for display or output, by the one or more processors, at least the updated current instruction.

The navigation data may comprise one or more navigation data packets. The method may further comprise decoding, by the one or more processors, the one or more data packets into respective display elements or audio output, and providing for display or output, by the one or more processors, the respective display elements or audio output of the one or more data packets.

The method may further comprise maintaining, by the one or more processors, a current location of a computing device comprising at least one of the one or more processors, and updating for output or display, by the one or more processors, the current location of the computing device using the navigation data.

The one or more data broadcasters may comprise one or both of a vehicle data broadcaster located on the vehicle and a transit location broadcaster located in a transit location through which a transit route for the vehicle passes through. The one or more data broadcasters may be configured for wireless unidirectional data connection to the one or more processors. The method may further comprise receiving, by the or more processors, the one or more instructions through a bidirectional data connection between the one or more processors and a network access point.

The method may further comprise filtering, by the one or more processors, the navigation data received from the one or more data broadcasters based on whether the navigation data corresponds to one or both of the vehicle or a transit route for the vehicle. The method may further comprise filtering, by the one or more processors, the navigation data received from the one or more data broadcasters based on one or more received user preferences. The navigation data may comprise one or more data advertisements for respective data streams broadcasted by the one or more data broadcasters to subscribed devices. The method may further comprise subscribing, by the one or more processors, to one or more data streams advertised in the filtered navigation data. A data stream may comprise one or both of: data corresponding to one or both of the vehicle or the transit route for the vehicle; and audio data corresponding to one or both of the vehicle or the transit route for the vehicle. The method may further comprise receiving, by the one or more processors, the audio data, and outputting, by one or more speakers communicatively coupled to the one or more processors, the audio data. The method may further comprise detecting, by the one or more processors, audio currently being output by the one or more speakers, and causing, by the one or more processors, the audio currently being output to be paused or reduced in volume, prior to outputting the audio data. The method may further comprise automatically subscribing, by the one or more processors, to at least one of the one or more data streams when the one or more processors are in broadcasting range of at least one of the one or more data broadcasters.

The one or more data broadcasters may be configured to broadcast audio data and navigation data. When at least one of the one or more data broadcasters are located inside the vehicle, the method may further comprise determining a location of the vehicle and the at least one of the one or more data broadcasters, and determining, based on the vehicle and the at least one of the one or more data broadcasters, a location of a user computing device. The vehicle may be moving.

The one or more data broadcasters may be located in at least one of inside the vehicle, at the vehicle, or near the vehicle. When the one or more data broadcasters are located inside the vehicle, a location of the one or more broadcasters may be stationary or changing. When the one or more data broadcasters are located at the vehicle, a location of the one or more broadcasters may be stationary or changing. When the one or more broadcasters are located near the vehicle, a location of the one or more broadcasters may be stationary.

Receiving the navigation data may further comprise receiving, by the one or more processors, metadata associated with the one or more data broadcasters. The metadata identifies the respective data broadcaster. The navigation data is part of the metadata.

Receiving the navigation data may further comprise receiving, by the one or more processors, a data stream and an audio stream, wherein the navigation data is part of the data stream.

The method may further comprise identifying, by the one or more processors, one or more keywords within broadcast data received from the one or more data broadcasters, and determining, by the one or more processors, based on the one or more keywords, a current location of a computing device comprising at least one of the one or more processors.

The method may further comprise encoding, by the one or more processors, the navigation data with a public-key signature.

The method may further comprise receiving, by the one or more processors, broadcast data from the one or more data broadcasters, wherein the broadcast data comprises the navigation data and at least one of the vehicle speed, heading of the vehicle, or a distance to or from a stop, and updating, by the or more processors based on the broadcast data, a current location of a computing device comprising at least one of the one or more processors.

The method may further comprise receiving, by the one or more processors, broadcast data from the one or more data broadcasters. The broadcast data comprises the navigation data and audio data. The audio data comprises labels. The method may further comprise determining, by the one or more processor based on the labels, to trigger a peripheral device to listen to an audio stream associated with the audio data, and transmitting, by the one or more processors to the peripheral device, instructions to listen to the audio stream.

Another implementation of the technology is generally directed to a method comprising broadcasting, by a broadcaster, navigation data corresponding to a transit location or vehicle associated with the broadcaster, wherein the navigation data is formatted for receipt by one or more computing devices configured to receive the navigation data and update one or more navigation instructions for a navigation route based on the broadcasted navigation data. The transit location may be a station, a station platform, a terminal, a vehicle stop, or a dock. The broadcaster may be further configured to broadcast audio data formatted for receipt by the one or more computing devices. The broadcaster may be stationary or moving. When the broadcaster is moving, the method may further comprise determining a location of a vehicle in which the broadcaster is positioned, determining, based on the location of the vehicle, a location of the one or more computing devices, and updating, based on the location of the one or more user computing devices, the one or more navigation instructions.

Yet another implementation of the technology is generally directed to a method comprising receiving, by one or more processors, audio streams from at least one broadcaster, filtering, by the one or more processors, the audio streams based on whether the audio streams correspond to information associated with the user, decoding, by the one or more processors, the filtered audio streams into respective output elements, and providing for display or output, by the one or more processors, the respective output elements of the audio streams.

The method may further comprise receiving, by the one more processors, the information associated with the user. Receiving the information associated with the user may comprise at least one of requesting, by the one or more processors, information associated with the audio streams from the at least one broadcaster, or requesting, by the one or more processors, authorization to access one or more databases of a user computing device to identify the information associated with the user.

The output elements may include one or more of a transcription of the audio streams, a visual notification associated with the audio streams, a haptic notification associated with the audio streams, or an audible notification associated with the audio streams. Providing the respective output elements for display or output may comprise at least one of displaying, by the one or more processors, at least one of the transcription of the audio streams or the visual notification, audibly outputting, by the one or more processors, the audible notification, or haptically outputting, by the one or more processors, the haptic notification.

Other implementations include corresponding computer systems, apparatus, and computer programs recorded on one or more computer storage devices, each configured to perform the actions of the methods.

### BRIEF DESCRIPTION OF THE DRAWINGS

FIG. 1 is a block diagram of an example system, according to aspects of the disclosure.

FIG. 2 is a block diagram of another example system, according to aspects of the disclosure.

FIG. 3 is a block diagram of a user computing device, audio peripheral, and display peripheral device receiving broadcasted data, according to aspects of the disclosure.

FIG. 4 is a flow diagram of an example process for broadcasting navigation data to receiving devices and updating navigation instructions, according to aspects of the disclosure.

FIG. 5 depicts a flow diagram of an example process for updating navigation instructions, according to aspects of the disclosure.

FIG. 6 is a block diagram of another example system, according to aspects of the disclosure.

FIG. 7 is a block diagram of a user computing device, audio peripheral, and display peripheral device receiving broadcasted data, according to aspects of the disclosure.

FIG. 8 is a flow diagram of an example process for broadcasting audio streams to receiving devices, according to aspects of the disclosure.

FIG. 9 depicts a flow diagram of an example process for providing audio streams as output elements, according to aspects of the disclosure.

FIG. 10 is a block diagram of an example computing environment for implementing the navigation system.

### DETAILED DESCRIPTION

### Overview

Aspects of the disclosure relate to the use of broadcast data broadcasted by broadcasters. For example, a navigation system for navigating users to desired destinations may use, at least in part, data broadcasted from locations at or near mass transit systems. The navigation system can include, for example, a server configured to transmit navigation data to one or more broadcasters, the broadcasters configured to broadcast the data, e.g., the navigation data, to one or more user computing devices and/or user peripheral devices, and/or a navigation platform configured to receive navigation requests and, in response, transmit navigation instructions. The navigation data can include, for example data useful for geolocating the user computing device (“geolocation data”) and/or data useful for navigating from one location to another. To provide accurate and reliable navigation instructions and navigation related information, navigation software relies on accurate geolocation by a computing device and up-to-date navigation information received either a priori or during the journey from map servers over wireless networks, such as cellular networks, Wi-Fi® wireless connections, and/or satellite systems, for guiding a user to a requested destination. To account for any gaps in the wireless networks used for geolocation, such as when traveling underground, indoors, in remote areas, or the like, the navigation system may use navigation-related data broadcasted from locations at, on, or near the mass transit systems in combination with the known location of broadcasters and other wireless transmitters, dead-reckoning sensors accessible to the computing device, and the progress on a route.

A computing device receives navigation data from a source of navigation information. The source of the navigation information may be a broadcaster storing information about the operation of a transportation system. The broadcaster may be configured to distribute, or output, audio for users but can, additionally or alternatively, be configured to broadcast the data wirelessly to the computing devices. For example, the broadcaster may utilize or implement Auracast™ such that the broadcaster can broadcast audio via Bluetooth®. A transportation system can be, for example, a subway, monorail, train, or bus system. For example, the broadcaster can be on a train or other vehicle, or on a physical transportation platform, such as a train station. Depending on the broadcaster location, the broadcaster may receive different information from one or more transit servers corresponding to a vehicle, a transit location, and/or a transit route through which the vehicle travels.

Broadcasters that are stationary, e.g., located on a physical transportation platform, may, in some examples, be referred to as beacons. However, as described above and herein, the broadcasters may be located in vehicles, e.g., subway, monorail, trains, buses, ferries, etc., that are moving. The information provided by moving broadcasters was, previously, irrelevant as the location of the vehicle was unknown and, therefore, the data broadcasted by the moving broadcasts was typically unusable for purposes of geolocation and/or navigation. The broadcasters described herein, however, can be used to convey, or broadcast, information from moving vehicles that know their location. For example, the broadcaster may receive geolocation information from the vehicle it is positioned in, such that the broadcaster may be associated with the known location of the vehicle. The known location of the vehicle can, therefore, be used to geolocate a user computing device within the vehicle, regardless of whether the vehicle is moving or not. In some examples, the known location of the vehicle, which is broadcasted by the broadcaster, can also be used to update navigation instructions being provided by the user computing device.

For example, if the broadcaster is on a vehicle, the broadcaster can transmit data useful for geolocating and navigating (collectively referred to herein as “navigation data”), such as data packets with data fields corresponding to identifiers for the route or vehicle the broadcaster is on, by embedding the identifier in a user-friendly plaintext field, or by encoding it in a binary format, or both. These identifiers may be unique at different layers of a transit system's hierarchy, for example, unique for a route but shared by all vehicles serving said route, unique for each vehicle, or unique for each segment of a vehicle, etc. Navigation data, such as geolocation data, can include, for example, the speed of the vehicle, the estimated-time-of-arrival (ETA) to the next station, the distance to the next or from the previous station, and/or the current heading of the vehicle. Navigation data, such as data used for navigation between locations, can include station information for stations along a route the vehicle is moving. Each station can have a respective unique identifier, user-friendly identifier, and/or a plaintext identifier that may be displayed or output to devices, such as station display devices or the display device of a user computing device. The navigation data can also include text corresponding to announcements that may be made on the vehicle. The announcements may include relevant safety.

As another example, the broadcaster can broadcast navigation data with data fields corresponding to information for a particular station, such as a subway station or a train station. Example data fields include the name of the station or particular platform within a station. The data fields can include an identifier, plaintext name, and/or user-friendly name for a platform, as well as the side the platform is relative to the station and the direction vehicles are traveling in from the platform. The data fields can also include information about vehicles approaching the station or platform, such as the name or ETA of the next train or trains scheduled to arrive. The navigation data can also include text corresponding to announcements that may be made on the platform. The announcements may include relevant safety or navigation instructions associated with the station, platform, dock, etc. In some examples, the announcement may include relevant instructions or information regarding a connecting train, flight, bus, etc.

The locations of the broadcasters may be known. For example, the broadcasters may be fixed, or stationary, at a given location, such as a platform, dock, bus stop, etc. In some examples, the broadcasters may be mobile, such as broadcasters located inside a vehicle, e.g., a car, bus, train, ferry, boat, etc. The user computing device and/or the navigation software being executed by the processors of the user computing device can use the known locations of these broadcasters to determine the location of the user computing device, with or without sensor fusion with other sensors accessible to the computing device, and, therefore, the user associated with the user computing device. The locations of the broadcasters may be known by the user computing device, for example, based on GPS coordinates (with or without elevation or floor info) of the broadcaster transmitted by the broadcaster, the user computing device accessing a database in which the coordinates are stored, offline copies of the coordinates stored on the user computing device, or the like. In some examples, the known location of the broadcasters, e.g., the coordinates of the broadcasters, may be based on an anchor point whose GPS coordinates are known. For example, based on signal strength measured by the user computing device and comparing against the expected transmit power either reported by the broadcaster or assumed, time of flight, or other forms of ranging between the broadcasters and the user computing device such as UWB or Bluetooth Channel Sounding, the user computing device can determine that the user computing device is close to or far away from a given broadcaster. In such an example, the user computing device may derive an approximate location, or, in some examples, the user computing device can trilaterate for a more accurate location if broadcasters and/or multiple wireless transmitters are sensed (e.g., identified) and the individual locations of those broadcasters and/or transmitters are known beforehand. In some examples, only the approximate location, such as whether the user computing device is located on a particular platform in a section of a station may be determined. In some examples, the location of the user computing device may be determined based on the navigation data broadcasted by the broadcasters. For example, if the navigation data indicates that the user computing device is two miles from the next stop, the navigation system and/or software can determine the location of the user computing device along the navigation route. In some examples, the approximate location of the user computing device may be determined based on keywords in the name or ID broadcasted by the broadcasters

In some examples, the location of the broadcaster is on a moving vehicle, e.g., a train and the route of the vehicle is known a-priori. The user computing device and/or software can use the known location of the broadcaster, e.g., the train car, the route of the train, the fact that the user computing device and, therefore, the user, is on said train, and the data that the user computing device and/or train is two miles from the next stop to determine the current location of the user computing device. The “location” of the broadcaster may also be inferred from a unique ID that is made part of the name or identifier associated with the broadcaster, which may be periodically broadcasted or advertised by the broadcaster.

The user computing device can receive the navigation data from one or more broadcasters and determine how and/or when to display or output the information based upon user preferences, e.g., visual, haptic, and/or audible notifications, user location, e.g., approaching a specific stop or station along the route, or other factors. Information can be displayed or visible output from a user computing device and/or a connected peripheral device, such as a wearable device. In some examples, the information may, additionally or alternatively, be audibly or haptically output from the user computing device and/or the connected peripheral device.

The user computing device and/or peripheral device can be any type of device operated by a user, including, for example, wearable devices, such as earbuds, helmets including a semi-transparent or transparent display for projecting display elements, watches, headphones, and glasses, as well as devices with augmented reality or virtual reality features. Other example user devices include laptops, tablets, personal computers, and mobile devices. Notifications can be rendered into audio through text-to-speech (TTS) technology, and output or displayed from a user computing device and/or a user peripheral device.

As another example, time-sensitive data, including announcements about a next station, a line terminal station, passport control, etc., can be output or not depending on user preference. The audio can be overlaid or injected into playback content or phone/video call audio, or completely override or pause playback content already output by speakers in the peripheral devices. For example, the device can detect audio currently being output by the one or more speakers, and cause the audio currently being output to be paused or reduced in volume, prior to outputting the audio data. Or the device may spatialize the audio data along with what is currently being rendered. The user computer device or device peripheral can also track the frequency with which an announcement is sent over audio, so as to not repeat an announcement or repeat the announcement with limited frequency.

In examples where the user computing device or peripheral device includes wearable devices such as smart glasses, headsets, or helmets including a semi-transparent or transparent display for projecting display elements, the navigation data received at these devices can be rendered in augmented or virtual reality and can be spatially located in a user's field of vision to line up with corresponding features of a transit location or vehicle where a user may be located. These elements can be used to inform or guide the user, e.g., through text, symbols, pictures, or other visual indicators and/or audio cues. Image and eye sensors can be used to track visual attention by a user wearing the device, to prioritize or de-prioritize the presentation of information based on the perceived or predicted focus of attention of the user.

In addition, or alternatively, the user computing device and/or peripheral device can include speakers or actuators for providing audio or haptic output, respectively. The fidelity or level of detail in elements displayed or output in response to receiving the navigation data can vary from implementation-to-implementation, for example based on available processing capabilities on a given computing device receiving the navigation data. For example, depending on available processing capabilities, text, audio, and other data can be displayed or output in a user-determined language, if the language is different from the language the navigation data is based on. According to some examples, the user computing device can translate the language to the user-determined language. In some examples, the user computing device can translate the navigation data and/or audio streams transmitted by the broadcasters into the user-determined language. In some examples, the user computer device can feed the received audio, its transcription, and/or any other received metadata into a artificial intelligence (AI) agent for further contextualization and application to the user's journey and to initiate other actions such as rebooking subsequent reservations in case of delays due to disruptions.

Broadcasters can be any type of device configured to broadcast data wirelessly, which can include audio streams or packets of data, to user computing devices. For example, the broadcaster may utilize, or implement, Auracast™ such that the broadcaster broadcasts audio via Bluetooth®. A broadcaster may broadcast to multiple devices at the same time, e.g., dozens or hundreds of devices concurrently, although the specific limitations vary from implementation-to-implementation. Broadcasters can be configured for unidirectional wireless communication with the user computing devices, e.g., configured only to broadcast data and not receive data from the user computing device. The broadcasters may still receive navigation data or other data from transit servers or devices. The broadcasters can be configured to broadcast data, including geolocation and navigation data, corresponding to a transit location or vehicle associated with the broadcaster, wherein the broadcast data is formatted for receipt by one or more computing devices configured to receive the broadcast data and determine the geolocation of the user computing device and/or update one or more navigation instructions for a navigation route based on the broadcast data.

Because transit locations may have several vehicles or platforms in close proximity to one another, user computing devices configured to receive broadcasted data can receive and filter broadcasted data to reduce the amount of data processed by the user computing devices overall. For example, the user computing device may subscribe to one or more broadcasters such that the user computing device receives broadcasted data from the broadcasters to which the user computing device is subscribed to (e.g., “subscribed broadcasters”). In some examples, the user computing device can selectively join and/or unjoin the broadcast from the subscribed broadcasters. In such an example, the user computing device may subscribe, or join, broadcasts relevant to a given portion of the navigation directions. For example, if the navigation includes taking a train for a portion of the navigation directions, the user computing device may subscribe to the broadcasts relevant to the train portion of the navigation. As an example, if the location of the user computing device is determined to be on platform 1, the user computing device can subscribe to the broadcaster located on platform 1 and receive broadcasted data from the broadcaster on platform 1, notifying the user computing device that the train for the navigation directions is approaching. Once the user computing device is determined to be located on the intended train, the user computing device can subscribe to the broadcaster located on the train and, subsequently and/or concurrently, unjoin from the broadcaster located on the platform.

The broadcasted data can include data packets with data fields corresponding to information about the operational status of train A, announcements related to platform 1, and so on, e.g., data relevant to the current navigation route. A device broadcast filter can be based on the current navigation route a user computing device is on. For example, if the current navigation instruction is to embark on train A on platform 1, the user computing device can filter broadcasted data from the subscribed broadcasters to receive, and process, only data related to train A or platform 1.

In some examples, the user computing device can filter the broadcasted data from the subscribed broadcasters to save only data corresponding to train A or platform 1. By filtering the broadcasted data from the subscribed broadcasters such that the user computing device only processes and/or saves relevant data, e.g., data relevant to the current navigation route, the computational efficiency of the user computing device is increased as the amount of memory and processing power is decreased. In particular, by only receiving, processing, and/or saving relevant data, less processing power is needed to determine whether information should be output via the user computing device and/or peripheral device. Further, less memory is needed as less data is received, processed, and/or stored. Additionally, by filtering the broadcasted data, computational efficiency is increased, such that processing power and RF power of the peripheral device are decreased, as less data has to be shared between the user computing device and the peripheral device.

As another example, if the user computing device is on a vehicle en route to a transit location, the user computing device can filter out broadcasted data from the subscribed broadcasters associated with transit stops en route to the final location. For example, the user computing device may filter the broadcasted data such that data related to stops other than the transit location are filtered out and, therefore, not processed by the user computing device. The user computing device can continue to receive broadcasted data, for example from a broadcaster of the vehicle en route to the transit location. In some examples, the user computing device may not filter any received broadcasted data, but instead filter what data is rendered or output through a user interface.

Navigation software can use navigation data, e.g., vehicle identifiers, estimated arrival/departure times, distance to the next location, station, etc., and distance information relative to a broadcaster to update display elements of a user interface corresponding to a navigation route. Data received from broadcasters can be exposed to navigation software or other types of software through an API, for example. The navigation software can update a user's location displayed on the user interface and be used to track current progress through a navigation route. The navigation software, operating system, or an application can also send back telemetry to a navigation platform, for example for providing live updates to the current traffic and/or operational conditions of the route, for when communication to the platform becomes available again.

Aspects of the disclosure provide for at least the following technical benefits. Broadcasts as described herein do not require device registration or log on, as appropriately configured devices can automatically receive broadcasted data and subscribe to relevant streams based on filtered data advertisements. A data advertisement is data that includes information for a stream that a user computing device or peripheral device can subscribe to whenever the device is in broadcasting range of a broadcaster. Data, e.g., metadata, text, and/or audio data, can be streamed to devices subscribed to the corresponding stream. As a result, less data is processed overall, thereby reducing the necessary processor power, power consumption, and processing cycles required for updating navigation information. Reducing processing power, power consumption, and processing cycles thereby increases the computational efficiency of the system.

Streams can also be provided directly to compatible receivers, such as wireless earbuds or headphones, hearing aids, or the like. Users regularly wear wireless audio devices as part of regular commutes on public transit. Audio receiving devices can be configured to listen to an audio stream broadcast from a broadcaster and/or a concurrent audio announcement made through speakers at a transit location. The audio receivers may automatically disable or reduce noise cancellation of other audio playback, e.g., music, audio from a video, audio from a call, or the like, while an audio announcement is on-going, in accordance with provided user preferences. The user computing device may also relay broadcast audio to aforementioned compatible receivers, in unmodified form, in filtered form, or mixed or spatialized with other content such as music or audiobooks.

The streams, which can include audio streams, can be provided directly to user computer devices, rather than peripheral devices, e.g., wireless earbuds or headphones, hearing aids, or the like. For example, the audio streams are typically provided to the peripheral devices once the user computing device subscribes to a given broadcast. However, the systems and methods described herein allow for the audio streams to be provided, additionally or alternatively, directly to the user computer devices. The user computing device can process the audio streams to identify what, if any, announcements are relevant to the user, providing a transcription of the audio streams, provide notifications associated with the audio streams, or the like. For example, the system may use information associated with the user to filter the audio streams to identify what announcements, if any, are relevant to the user. The system may access the information associated with the user after receiving authorization from the user to access one or more databases of the user computing device. For instance, the user may grant access to the calendar database but not the location database. The system may use the authorized information to determine what, if any, announcements are relevant to the user and, in response, generate an output, e.g., a notification. The notification may be a visual output, e.g., a transcription of the announcement, an audible output, e.g., the announcement provided via a speaker of the user computing device and/or peripheral device, a haptic output, or a combination thereof.

Functionality implemented on these and other devices for providing hearing assistance can be modified and leveraged for providing information, including navigation information, according to aspects of the disclosure. To that end, aspects of the disclosure can be layered on top of available technology to improve accessibility and adoption. As a result, computing resources and time is saved in developing special-purpose devices for implementing the navigation system as described. Adoption can increase due to the curb-cut effect, as streaming audio announcements and data directly to compatible receiving devices can assist users regardless of whether they are hard of hearing or require hearing assistance.

Visual aids can be implemented, for example using augmented reality/virtual reality compatible devices, such as smart glasses, headsets, helmets, and so on. The same wireless transmission technology, e.g., Bluetooth® based communication, can be leveraged both for broadcasting data from broadcasters as well as from computing devices to various audio devices.

### Example Systems

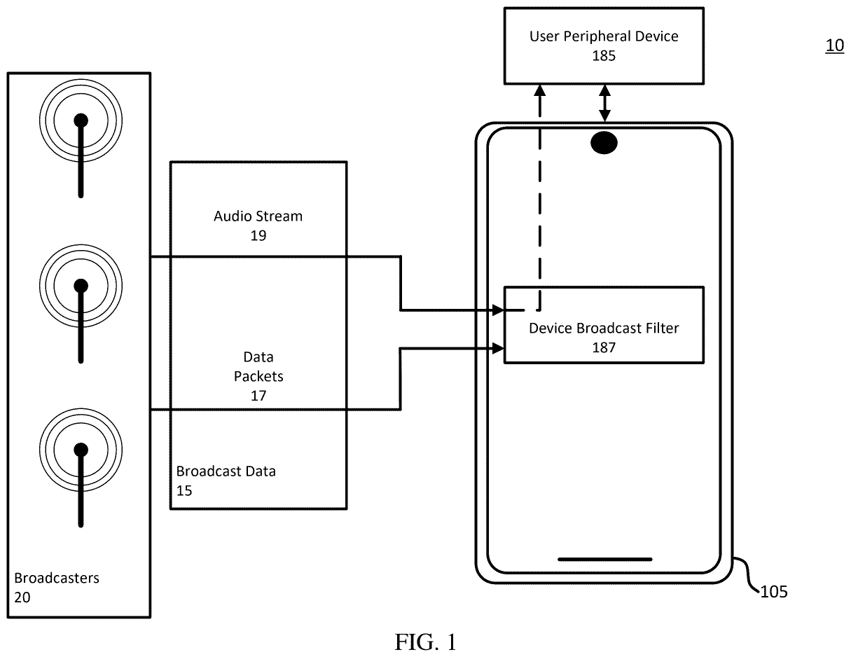

FIG. 1 is a block diagram of an example system 10, according to aspects of the disclosure. The system 10 can include one or more user computing devices, such as user computing device 105. The user computing device 105 can be any type of device that may be operated by a user, e.g., a laptop personal computer, mobile device, wearable device, such as headphones, a headset, earbuds, glasses, a helmet, a watch, a pendant or any device that may be draped over, worn, or attached to a user, and so on. The user computing device 105 can be configured with a user output, such as a display device, speakers, actuators for haptic or physical feedback, and so on.

Both the user computing device 105 and a user peripheral device 185 can be operated by a user. The user peripheral device 185 can be any device coupled to the user computing device 105, for example by wired or wireless connection. The user peripheral device 185 can be one or more earbuds, a headset, headphones, a remote control, or any other wearable device as described herein. While described as a wearable device, the user peripheral device 185 can be another user computing device 105, so long as the user computing device 105 and the user peripheral device 185 are coupled. Accordingly, the user peripheral device 185 being a wearable device is just one example and is not intended to be limiting. For example, the user computing device 105 and the user peripheral device 185 may be the same type of device, such as two ear buds. While the systems and methods described above and herein are with respect to both a user computing device 105 and a user peripheral device 185, the methods described herein may be implemented by a single device, e.g., a user computing device 105 or a user peripheral device 185. Accordingly, the use of both a user computing device and a user peripheral device 185 is just one example and is not intended to be limiting.

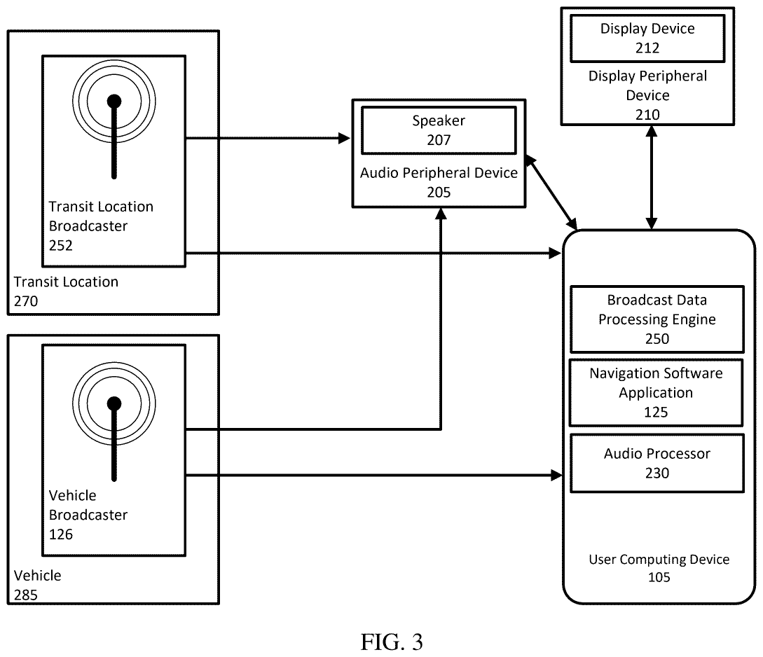

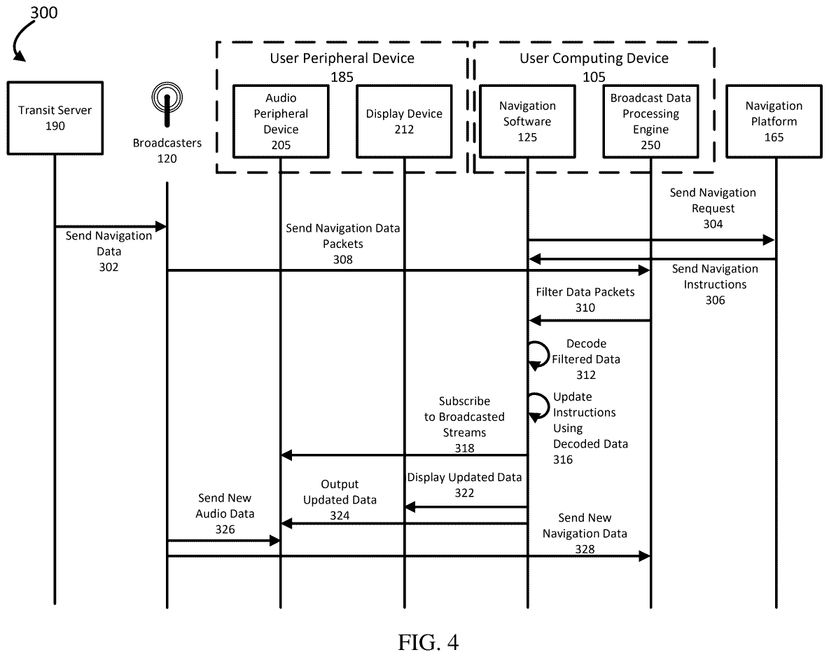

The user computing device 105 can subscribe to broadcasters 20, such that the user computing device 105 can receive broadcast data. The broadcast data 15 can include, for example, audio streams 19 advertised in the data packets 17. As described in more detail with reference to FIGS. 3 and 4, subscribing devices can automatically receive data broadcasts from the audio stream 19 as the user computing device 105 passes in and out of range of various different broadcasters.

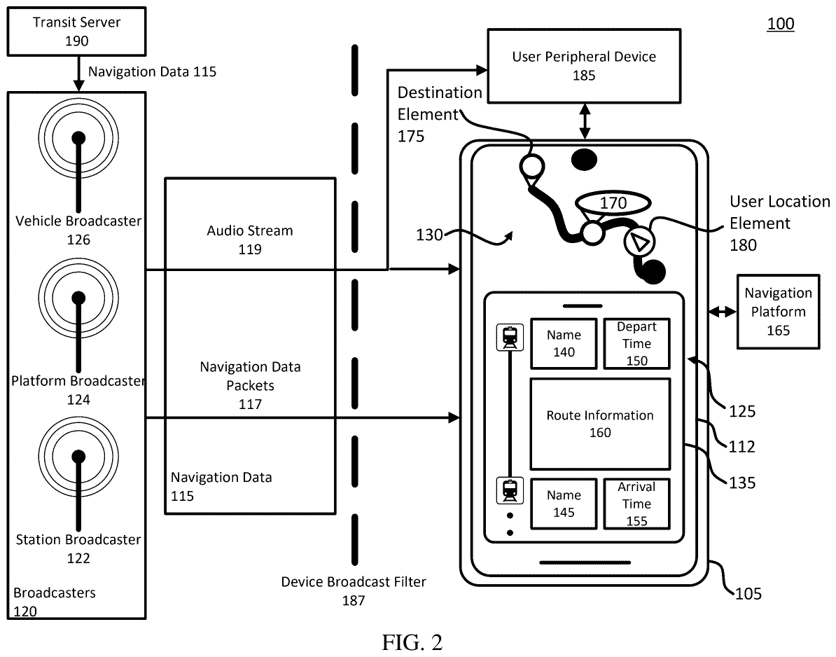

The user peripheral device 185 may receive data from the user computing device 105 or through other connections, such as broadcast data 15 transmitted by broadcasters 20 as described in more detail herein. In some examples, the user peripheral device 185 may receive data in the form of audio data, e.g., audio stream 19, transmitted by broadcasters 20. For example, the broadcaster may utilize, or implement, Auracast™ such that the broadcaster can broadcast audio data or streams. The broadcasters 20 implementing Auracast™ may, additionally, transmit data, such as data packets 17. The data packets may include navigation data packets 117, as discussed with respect to FIG. 2. In some examples, the user peripheral device 185 can output or display information through its own respective display device, speaker, actuator, and so on.

The user computing device 105 may receive the audio stream 19 and/or the data packets 17. The user computing device 105 may be configured to process the audio stream 19 to provide a transcription of the audio stream 19 for output via a user interface of user computing device 105. In some examples, the user computing device 105 may be configured to process the audio stream 19 based on information relevant to the user, the location, or the like to provide notifications for output via the user interface. For example, after receiving authorization from the user to access one or more databases in the memory of the user computing device, the system 10 may identify relevant events, travel information, locations, etc. corresponding to the audio stream 19. According to one example, the user may select specific sub-databases to which the application is granted access. For instance, the user may grant access to the calendar archive database but not the location history database.

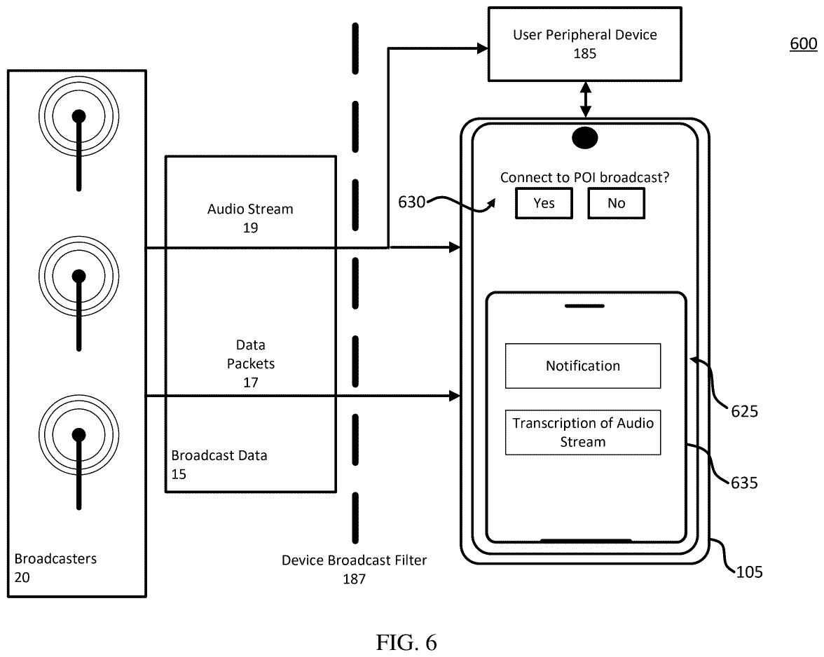

The user computing device 105 can be configured to filter out certain types of broadcasted data 15, such as by device broadcast filter 187. The device broadcast filter 187 can allow for only announcements relevant to the user location, activity, travel, etc. to be provided for output via a user interface on the user computing device 105, provided for output via a notification, and/or provided for output audibly via user peripheral device 185. FIG. 1 illustrates the filter 187 within the user computing device 105 such that the filter 187 is implemented by the user computing device 105, e.g., by one or more processors of the user computing device 105. For purposes of clarity, FIGS. 2 and 6 illustrate the filter 187 as being outside of the user computing device 105. However, in such examples, e.g., in FIGS. 2 and 6, the filter 187 can be implemented by the user computing device 105, e.g., by one or more processors of the user computing device 105. Accordingly, the filter 187 being outside the user computing device 105, as shown in FIGS. 2 and 6, is not intended to be limiting to the filter 187 being outside of the user computing device 105 and/or being implemented by something other than the user computing device 105.

According to some examples, use computing device 105 may include one or more user settings or preferences for types of broadcast data 15, e.g., general announcements, safety announcements, stop announcements, machine-data streams, audio streams, etc., to be filtered by filter 187 before the broadcast data 15 is transmitted to the peripheral device 185.

In some examples, the peripheral device 185 may identify one or more labels, e.g., metadata labels, of the broadcaster 20 when the broadcaster 20 is broadcasting broadcast data 15. For example, user computing device 105 may transmit labels to peripheral device 185. Peripheral device 185 may determine if there is a match between the label from user computing device 105 and the metadata labels embedded in or associated with broadcast data 15. When the labels correspond to the user settings and/or preferences, the peripheral device 185 decodes and renders the audio associated with the broadcast data 15.

In another example, the user computing device 105 can identify the labels of the received broadcast data 15 and/or execute a model to determine the relevance of the received broadcast data 15. Based on the label and/or determined relevance, the user computing device 105 can transmit or forward the filtered audio to peripheral device 185. In yet another example, based on the labels and/or relevant of the received broadcast data, the user computing device 105 can send instructions to the peripheral device to list, or receive, the broadcast data 15 of the broadcaster 20.

For example, the filter 187 can allow for only exception announcements, for example from conductors or the crew of a vehicle. An exception announcement can be labeled in the broadcasted data. Examples include announcements or information related emergencies, unplanned delays or closures, or periodic announcements when automated ones are malfunctioning. Because crowded transit locations may have several vehicles or platforms in close proximity to one another, user computing devices configured to receive broadcasted data can receive and filter broadcasted data to reduce the amount of data processed by the user computing devices overall, thereby reducing the necessary processor power, power consumption, and processing cycles required for updating navigation information. Reducing processing power, power consumption, and processing cycles thereby increases the computational efficiency of the system.

FIG. 2 is a block diagram of an example implementation of the system 10 of FIG. 1. The system 100 of FIG. 2 is a navigation system 100, according to aspects of the disclosure. The system 100 can include one or more user computing devices, such as user computing device 105. The user computing device 105 is shown displaying a navigation software 125, for which a user interface can be displayed or output through the device 105. In FIG. 2, the navigation software 125 is shown with a map display element 130 and a navigation instructions display element 135 for navigating a user of the device 105 to a destination. The display element 135 can include navigation instructions, displaying instructions for walking, scootering, driving, and bicycling and connections to make across various types of vehicles, such as trains, automobiles, buses, planes, subways, boats, ferries, and so on. The display element 135 can include names 140, 145, indicating the names or types of vehicles or transit routes the user is to disembark from or embark on as part of navigating to the destination. The names 140, 145 can be accompanied with depart time 150 and arrival time 155, indicating the time in which vehicles along the named transit routes are to depart or arrive at a platform, terminal, dock, station, etc., respectively. Route information 160 can include names, arrival/departure time, and other information corresponding to vehicles, transit lines, or other navigation information related to the route to the destination.

Map display element 130 can display the current location of the user computing device 105, for example as user location element 180. The navigation software 125 can update the current location of the user computing device based on received navigation data 115 by itself and/or other data and algorithms, such as GPS, IMUs, WiFi signatures, etc. For example, based on a predetermined position of a broadcaster corresponding to a station, platform, or other transit location, the navigation software 125 can update the current location of the device 105 to correspond to the location of the respective transit location for the broadcaster. The map display element 130 can also show a destination display element 175 indicating the location of the destination of a navigation route, as well as any transit locations along the route, as transit display element 170.

The navigation software 125 can receive and send data from and to a navigation platform 165. The navigation platform 165 can be a computing platform configured to receive requests to generate navigation instructions for routing users of computing devices to requested destinations. The navigation platform 165 can receive and maintain various types of information, such as position information related to the position of a computing device relative to a destination, traffic data indicating the state of traffic or conditions on roads or paths en route to a requested destination, map data indicating safe and legal roads or paths to the requested destination, and so on.

Data, such as data for navigation uses, can be sent as payloads in periodic advertisements, for example, associated with a Broadcast Isochronous Group (BIG), that may include one or more streams. For example, the payloads can be sent in periodic advertisements associated with a BIG, such as in a particular metadata field defined in the periodic advertisement. In some examples, data can be sent as an additional data-only stream in the same BIG that is being used for sending audio streams. In some examples, data can be sent as a separate BIG containing just the data stream. In some examples, when the data is sent as a stream, user computing devices can be configured to decode the data according to a custom codec.

To keep the data payload small, the full data field can be broken up into smaller atomic pieces and spread over multiple slots. The rate can be different for different classes of data. The priority can also change. For example, if periodic advertisements (“PAs”) spaced 100 ms apart is chosen, then the first PA can contain the name of the train, the second PA the navigation information, such as the distance to the next station, the third PA the next station, the fourth PA the previous station information, alternating with the station after next station's info, followed by a repetition of the cycle. In another example, the breaking up of payload may not occur on atomic boundaries and a PA can contain a portion of an atomic piece or multiple pieces partitioned evenly or unevenly amongst a group of PAs. In another example where the payload is transported over an isochronous channel, what is described above for PAs would be applied to SDUs of the isochronous channel. For anti-spoofing purposes, the payload may also include a signature, such as a 48 octet EDCSA-192 hash, computed from the combination of navigation data, a broadcaster identifier, the timestamp, and a key.

The data broadcasting can be interrupted, for example by special announcements. For example, an announcement from the conductor of a vehicle can be scheduled for the immediate next slot and subsequent N slots, interrupting the normal rotating sequence, followed by a resumption of the rotating sequence when the announcement is over.

The user computing device 105 can subscribe to data/audio streams 119 advertised by broadcasters 120. As described in more detail with reference to FIGS. 3 and 4, subscribing devices can automatically receive data broadcasts from the data/audio stream 119 as the user computing device 105 passes in and out of range of various different broadcasters, such as vehicle broadcaster 126, platform broadcaster 124, and/or station broadcaster 122. For example, the computing device 105 can subscribe to a stream broadcast from a vehicle broadcaster 126 for a vehicle the user computing device 105 is located in. When the user disembarks from the vehicle onto a station platform, the user computing device 105 can subscribe to streams from a platform broadcaster 124 and/or station broadcaster 122. In such an example, the user computing device 105 may unjoin from the stream broadcast from the vehicle broadcaster 126 when joining the stream from the platform broadcaster 124. If the user computing device 105 is already subscribed to a given stream, the device 105 does not have to re-subscribe before automatically receiving data from a broadcasted stream. The user computing device 105 can provide updates for display or output, for example whenever the device 105 begins receiving data from a different stream. The updates can include any announcements or changes in a schedule, safety or operational announcements, and so on.

According to some examples, when the user computing device 105 is subscribed to the vehicle broadcaster 126, the user computing device 105 can determine its geolocation based on the location of the vehicle broadcaster 126. For example, the vehicle broadcaster 126 may know its location based on the processors of the vehicle inherently knowing its location. For example, a train may include one or more processors that know through communication with a dispatching system, or determine through sensors, the location of the train along a given route. The processors of the train may transmit, or provide, the location of the train to the vehicle broadcaster 126 such that the location of the vehicle broadcaster 126 is known based on the known location of the train. The vehicle broadcaster 126 can broadcast the location as part of the navigation data 115, such that the user computing device 105 can determine its location.

In some examples, a combination of data packets, e.g., navigation data packets 117, and streams, e.g., data/audio stream 119, are used, for example based on the congestion of a given transit location. For example, data packets require less bandwidth overall to broadcast but are subject to re-broadcasting in case some packets are dropped or not received by a user computing device. Depending on the number of devices being broadcasted to and/or the number of streams being broadcasted by the broadcasters 120, the broadcasters 120 can be configured to adjust the ratio of streams versus data packets to reduce the broadcasting load. For example, if the transit location or vehicle is crowded, the broadcasters 120 can transmit more packets versus streams, and vice versa when the transit location or vehicle is not crowded. Specific thresholds for determining the rate of streams versus packets can be predetermined or empirically determined, for example based on measured data drop rates under different conditions.

The user computing device 105 can be configured to filter out certain types of broadcasted data, such as by device broadcast filter 187. For example, the filter 187 can allow for only safety announcements, for example from conductors or the crew of a vehicle. An exception announcement can be indicated in the broadcasted metadata. Examples include announcements or information related emergencies, unplanned delays or closures, or periodic announcements when automated ones are malfunctioning. Because crowded transit locations may have several vehicles or platforms in close proximity to one another, user computing devices configured to receive broadcasted data can receive and filter broadcasted data to reduce the amount of data processed by the user computing devices overall, thereby reducing the necessary processor power, power consumption, and processing cycles required for updating navigation information. Reducing processing power, power consumption, and processing cycles thereby increases the computational efficiency of the system.

FIG. 3 is a block diagram of a user computing device, audio peripheral device, and display peripheral device receiving broadcasted data, according to aspects of the disclosure. Audio peripheral device 205 and display peripheral device 210 are examples of a user peripheral device 185 that can be communicatively coupled to the user computing device 105. In FIG. 3, user computing device 105 is shown with a broadcast data processing engine 250, navigation software 125, and audio processor 230. Audio processor 230 can be configured for processing and outputting audio data, for example from audio streams broadcasting from broadcasters 120. The audio processor 230 can also be configured for processing incoming navigation data containing text through a text-to-speech (TTS) function before outputting audio data, for example through speaker 207. In some examples, audio processor 230 can be configured for processing incoming navigation data containing audio streams and converting the audio streams into text before outputting the text via a display, e.g., display device 112 or display device 212.

Broadcast data processing engine 250 can be configured for receiving and processing navigation data packets and streams from the broadcasters, including subscribing to streams and filtering data packets, for example as described herein with reference to FIGS. 3 and 4.

Audio peripheral device 205 can include a speaker 207 and be configured to receive audio from a stream, which can be either from a broadcaster, such as a vehicle broadcaster 126 on a vehicle 285 or transit location broadcaster 252 at a transit location 270, such as a station, dock, platform, terminal, and so on. The audio peripheral device 205 can also receive streams or data for outputting from user computing device 105, which can be received from broadcasters 120. Display peripheral device 210 can be any device with a display device 212, such as a smart watch, smart glasses, a headset, and so on. As described in more detail with reference to FIG. 4, display and/or output elements can be displayed or output by audio peripheral device 205 and display peripheral device 210 after receipt and processing by the user computing device 105. In some examples, the operations performed can be performed by the audio peripheral device 205 and/or the display peripheral device 210 directly, without the user computing device 105.

FIG. 6 is a block diagram of an example implementation of the system of FIG. 1, according to aspects of the disclosure. The system 600 can include one or more user computing devices, such as user computing device 105. The user computing device 105 is shown displaying a companion broadcasting software 625, for which a user interface can be displayed or output through the device 105.

In FIG. 6, the companion broadcasting software 625 is shown with a request display element 630 and a broadcast display element 635. The broadcast display element 635 can include a transcription of the audio stream 19, notifications related to the audio stream 19, or the like.

Request display element 130 can display a list of one or more possible broadcasts being output by broadcasters 120. The request display element 130 can provide one or more user inputs for a user to select whether to connect to a given broadcast. The user computing device 105 can subscribe to audio streams 19 advertised in the broadcast data 15. Subscribing devices can automatically receive data broadcasts from the audio stream 19 as the user computing device 105 passes in and out of range of various different broadcasters.

Based on one or more inputs received by the user computing device 105 corresponding to the selection to connect to a given broadcast, the companion broadcasting software 625 can update the broadcast display element 635 based on the received broadcast data. For example, the user computing device 105 can receive audio streams 19 from the broadcasters. The user computing device 105 can transcribe the audio streams 19, via the audio processor 230, and provide the transcription via the broadcast display element 635.

In some examples, the request display element 630 can display requests for information, authorization to access certain information, or the like. For example, after connecting to a given broadcast, the request display element 630 can display a request for information associated with the broadcast, such as a ticket number to track a wait time. As an example, the user may have placed an order at a restaurant and the order may be associated with a ticket or order number. The restaurant may announce the order numbers for respective users to pick up their order. The user computing device 105 can receive, in response to the request, the user's order number such that the announcements may be filtered based on the user's order number. In another example, the information associated with the broadcast may be travel information. For example, if the user has a trip planned, including a flight, the request display element 630 may request the flight information, confirmation of flight information identified from a calendar event, or the like. The user computing device 105 can then filter the announcements at the airport such that only those relevant to the user's flight are provided for output. In some examples, the request display element 630 displays an authorization request. The authorization request is for the user to provide authorization to the system to access one or more databases of the user computing device 105, such as the calendar database, location database, etc.

The user computing device 105 can be configured to filter out certain types of broadcasted data, such as by device broadcast filter 187. For example, the filter 187 can allow for only announcements relevant to the user to be provided for output via the user computing device 105 and/or peripheral device 185. Examples include announcements or information related to the user's travel plans, current location, activities, etc. The filter 187 may filter the audio streams or announcements based on user preferences or information associated with the user. For example, if the user provides authorization to access databases of the user computing device 105 and/or provides information in response to requests via request display element 630, the user computing device 105 can use the information associated with the user to filter the audio streams such that only those relevant to the user are provided. In some examples, the user computing device 105 can use the information associated with the user to provide notifications regarding announcements, or audio streams, relevant to the user.

As an example, if the system determines that the user computing device 105 is as a given point of interest, such as a train station, and the user computing device 105 subscribes to the broadcasted data transmitted by broadcasters at the train station, the request display element 630 may seek information regarding what train the user is taking, a picture of the purchased ticket, access to the ticket via the digital wallet or the like. The companion broadcasting software 625 may process the information to determine what audio streams should be provided as an output element as compared to which audio streams should be filtered and, therefore, not output by the user computing device 105. The audio streams that the companion broadcasting software 625 subsequently provides for output as an output element are those that are relevant to the user based on the information associated with the user. For example, upon knowing the train the user is taking, the companion broadcasting software 625 may output one or more output elements for announcements associated with the train. The output elements include, for example, a visual transcription of the announcement, a notification regarding the arrival of the train, notifications regarding what platform the train will be arriving at, etc.

Because the broadcasters are transmitting broadcast data 15 for all users, user computing devices configured to receive broadcasted data can receive and filter the broadcasted data to reduce the amount of data processed by the user computing devices overall, thereby reducing the necessary processor power, power consumption, and processing cycles required for updating navigation information. Reducing processing power, power consumption, and processing cycles thereby increases the computational efficiency of the system.

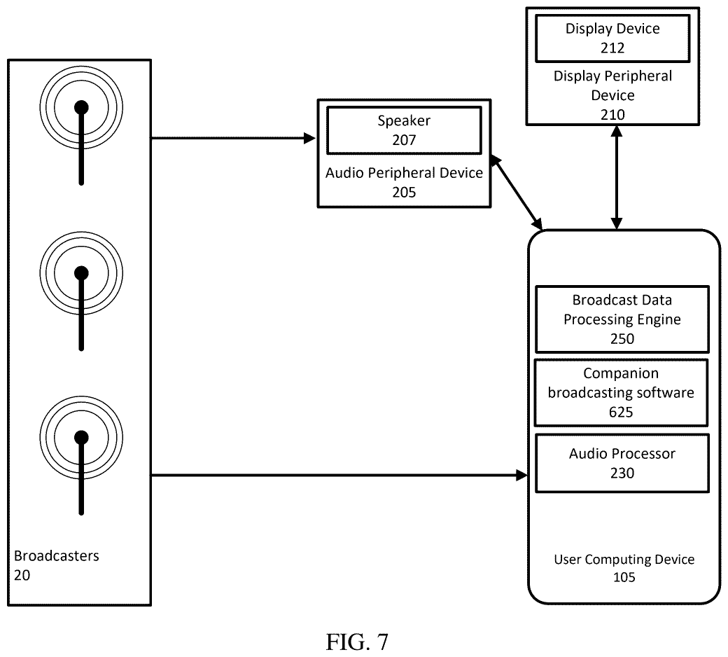

FIG. 7 is a block diagram of a user computing device 105, audio peripheral device 205, and display peripheral device 210 receiving broadcasted data 15, according to aspects of the disclosure. FIG. 7 is similar to the block diagram of FIG. 3, but, instead of navigation software 125, FIG. 7 includes companion broadcasting software 625.

In FIG. 7, user computing device 105 is shown with a broadcast data processing engine 250, companion broadcasting software 625, and audio processor 230. The audio processor 230 can also be configured for processing incoming audio streams 19 containing speech through a speech-to-text function before outputting audio data, for example through a user interface of user computing device 105 and/or display device 212 of display peripheral device 210.

Broadcast data processing engine 250 can be configured for receiving and processing broadcast data 15 streaming from the broadcasters 20. The broadcast data may include, for example, data packets 17 and audio stream 19. The broadcast data processing engine 250 can, additionally, be configured to subscribe to streams and filter data packets, for example as described herein with reference to FIGS. 1-6.

According to some examples, the systems of FIGS. 1-3 and 6-7 may be used to provide an independent verification as to the accuracy in the broadcast data and, in some examples, provide supplemental information based on the determined accuracy. For example, after receiving authorization to access databases of the user computing device 105 and after the user computing device 105 subscribes to a given stream, the system may compare the accuracy of the information in the broadcast data as compared to what is actually occurring at a given location. The system may do this by comparing what the data transmitted by the broadcasters 120 to what the user computing device 105 is doing, e.g., location data associated with the device, data obtained by sensors the user computing device, or the like. If the data transmitted by the broadcasters corresponds to what the user computing device 105 is doing, the data may be identified as accurate. In contrast, if the data transmitted by the broadcasters does not correspond to what the user computing device 105 is doing, the data may be identified as inaccurate and the system may use information from the user computing device 105 to provide supplemental announcements.

According to some examples, a data feed, such as a feed for public transportation schedules and associated geographic information, may be provided by transit authority to server computing device 515 and/or storage device 530. The data feed may, in some examples, be different from the data being broadcasted by the broadcasters 20. In such an example, e.g., when the data feed is different than the data being broadcasted, the broadcast data and/or sensor data obtained by the user computing device 105 may be used to update the data feed. For example, if the broadcast data 15 and/or sensor data of the user computing device 105 indicates that a train is at a given location different from the location indicated by the data feed, the data feed may be updated. In such an example, the data feed may be updated to reflect the actual location of the train, an updated schedule of the train, etc.

As an example, if the user computing device 105 is at a train station and the user is waiting for a specific train, the user computing device 105 may subscribe and receive broadcast data related to the specific train the user intends to travel on. The broadcast data can include, for example, an announcement regarding when the train is expected to arrive at the platform. The expected arrival time may be based on a set train schedule. In actuality, however, the train may fluctuate in arrival time as compared to the train schedule. For example, based on information obtained from user computing devices, the system may determine that the train chronically arrives at a given platform five minutes later than the time indicated on the train schedule. The system may, therefore, supplement the broadcast data with an announcement that, while the train schedule indicates the train is set to arrive at 11:00 am, the train typically arrives at 11:05 am. The supplemental announcements may be provided as output elements, such as a visual element within map display element 130, a navigation instructions display element 135, broadcast display element 635, or the like. In some examples, the supplemental announcements may be provided as audible or haptic output elements.

According to some examples, the user computing device 105 may infer the train's arrival based on a change of signal strength of the train's broadcasters. For example, the user computing device 105 may detect a lack of broadcast data, e.g., not detecting a particular train broadcaster's advertisements, and, therefore, a low to no signal strength of the train's broadcasters. However, as the train approaches, the signal strength of the train's broadcasters may increase such that, when the signal strength exceeds a predetermined threshold, the user computing device 105 may determine that the train has arrived. In some examples, the user computing device 105 may determine the arrival and/or departure of a given train based on a change in the signal strength of a given train's broadcasters.

### Example Methods

FIG. 4 is a flow diagram of an example process 300 for broadcasting navigation data to receiving devices and updating navigation instructions, according to aspects of the disclosure. The following operations do not have to be performed in the precise order described below. Rather, various operations can be handled in a different order or simultaneously, and operations may be added or omitted. The transit server 190 sends navigation data to broadcasters 120, according to line 302. The navigation data can be navigation data 115, for example as described with reference to FIG. 2.

Navigation software 125 can send, or transmit, a navigation request to navigation platform 165, according to line 304. The navigation request can be received from user input including a desired destination. The navigation platform 165 can receive the navigation request and send navigation instructions, according to line 306. The sending of the navigation request and the instructions can be performed over a bidirectional communication connection, e.g., through cellular, WiFi, satellite access points, and so on, between the navigation platform 165 and the navigation software 125, e.g., the user computing device. These types of connections may not be available along the entire route specified by the navigation instructions received from platform 165, and aspects of the disclosure provide for updating or providing navigation data sent through unidirectional broadcasters, placed at locations in which other types of connections are less reliable or unavailable. For example, the connections may lapse, be interrupted, become unreliable, or the like when a vehicle in which the user is traveling in goes underground, is in a remote area, etc.

In some examples, such as when navigation platform 165 is unreachable, navigation software 125 can determine navigation instructions based on navigation information and/or instructions stored in a database. In some examples, the navigation instructions may be stored offline, such as in the memory of the user computing device 105.

According to line 308, broadcasters 120 send navigation data packets to user computing devices implementing broadcast data processing engines, such as broadcast data processing engine 250. For example, broadcast data processing engine 250 may receive broadcast data from one or more broadcasters 120 after the user computing device 105 subscribes to or reads the metadata advertised by the given broadcasters 120. Subscribing to broadcasters 120 may include, in some examples, the user computing device 105 decoding the metadata used by a broadcaster 120 to declare the identity and/or characteristics of the broadcasters 120. The identity and/or characteristics of the broadcasters 120 may be picked up, or determined, by the user computing device 105 while scanning for broadcasters 120, without needing to lock on to the stream and decode the stream.

The user computing device 105 may, in some examples, identify broadcasters 120 to subscribe to based on a navigation route received as part of the navigation instructions, according to line 306. The user computing device 105 may, in some examples, determine broadcasters 120 that are expected to be along the navigation route. The user computing device 105 may subscribe to one or more of the broadcasters 120 along the navigation route.

In some examples, a smart assistant associated with the user computing device 105 may set a navigation route for the user computing device based on historical navigation data. For example, after receiving authorization from the user to access one or more databases of the user computing device, the smart assistant may determine that the user associated with the user computing device 105 typically leaves work at 5:30 pm each Tuesday. For instance, the user may grant access to the navigation database but not the e-mail database. In some examples, the user may grant access to the calendar database, such that the smart assistant can determine if the user has a theater ticket or dinner reservation for a given night. In such an example, the user computing device 105 can determine whether the user computing device 105 has entered a train station that would allow for the user associated with the user computing device 105 to arrive at the event, e.g., theater or dinner reservation, with the appropriate time margin.

The data carried by the navigation data packets can include telemetry data or other data specifying details about vehicle, stations, platforms, or transit routes, among other things. The navigation data packets can also include data advertisements for subscribing to different streams of data broadcast by the broadcasters. The packets can also include digital signatures, generated using Public Key Infrastructure (PKI) components, to facilitate authentication of the broadcaster and/or its transmitted data. The streams can include data specific to a particular vehicle, transit route, or transit location. The streams can include more data, e.g., as metadata in predefined formats, or unstructured data, such as text. The streams can also include audio data.

Packets can be sent in groups, with each packet storing a subset of navigation data available from the broadcasters. For example, to keep the individual data payloads small, e.g., smaller than 16 bytes, multiple pieces of information can be sent across multiple packets. For example, one packet can indicate the name of a vehicle, the next packet can indicate operating status, another packet can indicate the next/previous transit location where the vehicle can stop, and so on. The packets can be sent multiple times, as a cycle. The packets can be numbered, and the broadcast processing engine can be configured to determine whether packets are missing from a group and receive the packet on the next cycle of broadcast from a broadcaster.

The broadcast data processing engine 250 can filter received data packets, according to line 310. As described in FIGS. 1, 2, and 6, a device broadcast filter 187 can be implemented to filter out data packets and streams according to different factors, such as user preference or whether the broadcasted data corresponds to a navigation route specified by navigation instructions to a user requested destination. For example, if the current instruction specifies riding a subway train to a particular station, the processing engine 250 can filter incoming data to allow for only data sent from a broadcaster corresponding to the subway train or the particular station. By filtering the data, the user computing device can process less data overall, which improves the computational efficiency of the user computing device at least through reduced power consumption and fewer processing cycles to process less data.

The navigation software 125 decodes the filtered data, according to line 312. Decoding the data can include generating corresponding display or output elements for display or output through a user interface of a computing device. For example, metadata in received filtered packets can be rendered for display as various different display elements, such as the elements shown and described with reference to FIGS. 1, 2, and 6. Text can be converted to speech through text-to-speech (TTS) technology, such as a machine learning model trained to generate speech from input text. In some examples, audio or speech may be converted to text.

The navigation software 125 updates instructions using the decoded data, according to line 316. For example, based on the received data packets indicating a different arrival time for a vehicle versus that was originally provided in the navigation instructions, the navigation software can update the arrival time based on the data received from the broadcaster for the vehicle. As another example, the current location of the user computing device along a navigation route can be updated, based on telemetry data specifying the position of the user computing device relative to a broadcaster in broadcasting range. As another example, the navigation software can provide updates as input into an AI agent.

The navigation software 125 instructs peripheral device 185 to subscribe to broadcasted streams, according to line 318. The filtered navigation data packets can include data advertisements for subscribing a device to one or more streams of data broadcast by a broadcaster. When a device is subscribed, the device can automatically receive data sent over the stream by a broadcaster. The data may be, for example, navigation data, audio data, or the like. For example, the broadcaster may implement Auracast™ such that the broadcaster can broadcast audio for human consumption and transmit navigation data. As part of the subscription, the navigation software 125 can cause an audio peripheral in communication with the navigation software 125, such as the audio peripheral device 205, to automatically receive audio data sent from audio streams of a broadcaster. Thereafter, the audio peripheral device 205 can automatically receive new audio data from the broadcasters 120, according to line 326. As described with reference to FIGS. 1 and 2, the audio data can include updates or safety announcements related to the vehicle, transit route, or a transit location through which a vehicle passes through as part of a respective transit route.

The navigation software 125 causes updated navigation data to be displayed on the display device 212, according to line 322. For example, the decoded data can be represented as display elements 140-160 as shown with reference to FIG. 2. In addition, or alternatively, the navigation software 125 causes the updated data to be output by the audio peripheral device 205, according to line 324. For example, the audio peripheral device 205 can output received announcements from data received from a broadcasted broadcaster, or speech data generated by the navigation software 125 summarizing updates made to the navigation instructions based on the received navigation data from the packets.

At a later time, the broadcasters can send new audio data to the audio peripheral device 205, according to line 326. The new audio data can be received and processed directly by the audio peripheral device 205, for example based on an earlier subscription to the corresponding audio stream sending the audio data. In some examples, the audio data is received and processed by the navigation software 125 and/or the broadcasting data processing engine 250, which can be configured to send the data for output on speakers in a peripheral device or user computing device. Broadcasting data processing engine 250 can choose to receive and process navigation data, according to line 328. As with the audio data, the navigation data can include data packets from a subscribed stream by the navigation software, such that data is automatically received from the broadcaster when in range of a user computing device without first re-filtering the data.

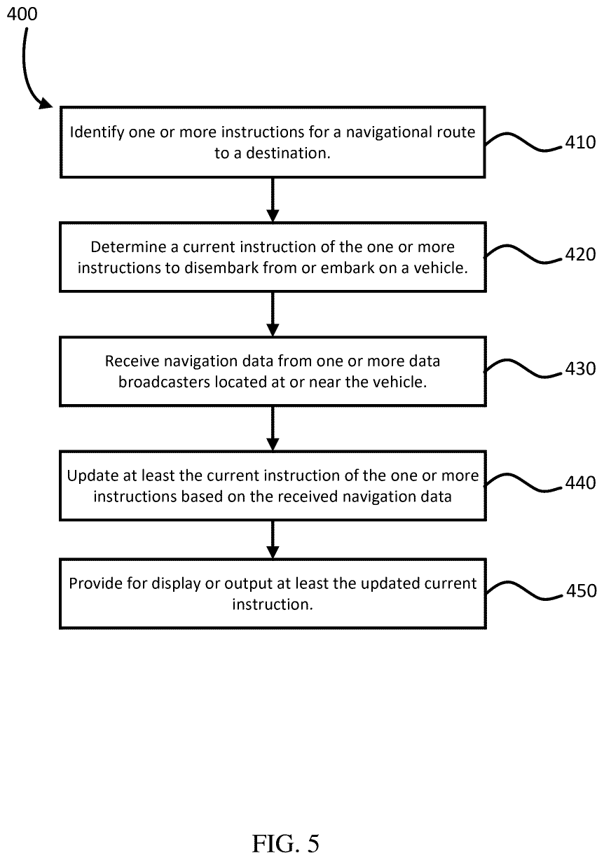

FIG. 5 depicts a flow diagram of an example process 400 for updating navigation instructions, according to aspects of the disclosure. The following operations do not have to be performed in the precise order described below. Rather, various operations can be handled in a different order or simultaneously, and operations may be added or omitted. The example process 400 can be performed on a system of one or more processors in one or more locations, such as the navigation system 100 of FIG. 2.

The one or more processors receives or computes one or more instructions for a navigation route to a destination, according to block 410. As described above with reference to FIGS. 2 and 4, the one or more processors can be at least partially implemented in the user computing device 105 implementing navigation software 125. The navigation software 125 is configured to send a request to navigate to a destination to the navigation platform 165. The navigation platform 165 can send the one or more instructions for reaching the destination along one or more routes or paths. In some examples, the navigation software 125 is configured to generate and display or output the one or more instructions without communicating with a navigation platform.

The one or more processors identifies a current instruction of the one or more instructions to disembark from or embark on a vehicle, according to block 420. For example, the current instruction can be to embark on or disembark from a vehicle at a transit location, such as transit location indicated by transit display element 170 as described with reference to FIG. 2.

The one or more processors receive navigation data from one or more data broadcasters, according to block 430. For example, the navigation data can be the navigation data 115 transmitted from the broadcasters 120, as described with reference to FIG. 2. The one or more processors can receive the navigation data as one or more navigation data packets. The navigation data packets can be broadcast in groups that are repeated to reduce the chance that one or more packets are dropped during broadcasting. In some examples, the one or more processors receives audio data from the one or more data broadcasters, such as a broadcaster implementing Auracast™. For example, the broadcaster can broadcast audio for human consumption and also be used for broadcasting navigation data.

The broadcasters can be configured for wireless unidirectional data connection to the one or more processors, meaning that the broadcasters send data but do not receive data over the air, allowing for the scalability to an unlimited number of receiving devices, e.g., user computing devices and/or peripherical devices, and increased bandwidth. As part of receiving the one or more navigation instructions, the one or more processors may do so through a bidirectional data connection between one or more processors and a network access point. For example, the navigation platform 165 of FIG. 2 can send the one or more navigation instructions through a cellular, Wi-Fi®, or satellite access point of network 560, which the one or more processors are configured to receive data from. However, as these access points are not always available, particularly in underground or remote transit locations, aspects of the disclosure provide for updating the navigation instructions using data received from the wireless unidirectional data connections formed by the broadcasters.

The data broadcasters can include broadcasters on a vehicle being ridden by a user navigating according to the navigation instructions. The broadcasters may also include broadcasters on stations, terminals, depots, platforms, or other transit locations, for example as described herein with reference to FIG. 2.

As described with reference to FIGS. 2 and 4, the one or more processors can filter the navigation data received from the one or more data broadcasters based on whether the navigation data correspond to one or both of the vehicle or a transit route for the vehicle. In addition or alternatively, the one or more processors can filter the navigation data based on user preferences, for example to omit any updates except for safety or emergency announcements.

As described with reference to FIGS. 2 and 3, the data packets can include various data fields and data relating to navigation information corresponding to a vehicle, a transit route for the vehicle, transit locations through which a vehicle passes through following the transit route, and so on. The one or more processors can decode the data packets into respective display elements or audio output. For example, updated departure times, arrival times, and other route information can be displayed on display device 112 of user computing device 105. As another example, text data sent over the packets can be converted to audio and output through the user computing device 105 and/or a connected audio peripheral device, such as ear buds.

The data packets received can be associated with different data streams including data, such as telemetry data, text data, and/or audio data. For example, the data packets can include data advertisements with information for subscribing to a respective stream. When a device communicatively coupled to the one or more processors is subscribed to a stream, the device can automatically receive incoming data on the stream, for example whenever the device is in broadcasting range of a broadcaster broadcasting the stream. User computing devices may automatically subscribe to streams for vehicles or stations that are part of a daily commute or routine travel, for example. In this way, the user computing device can avoid receiving and processing data not associated with these subscribed streams, improving overall efficiency at least by reducing the amount of data processing required.

The one or more processors update at least the current instruction of the one or more instructions based on the received navigation data, according to block 440. For example, the navigation data may include an updated arrival time for the vehicle. The one or more processors can update other data, such as a current location of a computing device including at least one of the one or more processors. The broadcasters can provide the navigation data needed for updating the current location of the user computing device, for example when the user computing device is underground or otherwise unavailable to receive data from other sources, such as through GPS, cellular, WiFi, and/or satellite connection.

The one or more processors provides for display or output, at least the updated current instruction, according to block 450. For example, the one or more processors can update the corresponding display element indicating the arrival time, e.g., arrival time 155 as shown in FIG. 2. For example, a user computing device or peripheral with speakers can output audio data corresponding to the updated current instruction. As another example, the speakers can output audio data received in a subscribed stream corresponding to the one or more data packets, or process text data in a packet through a text-to-speech (TTS) technology to audibly output the text as speech.

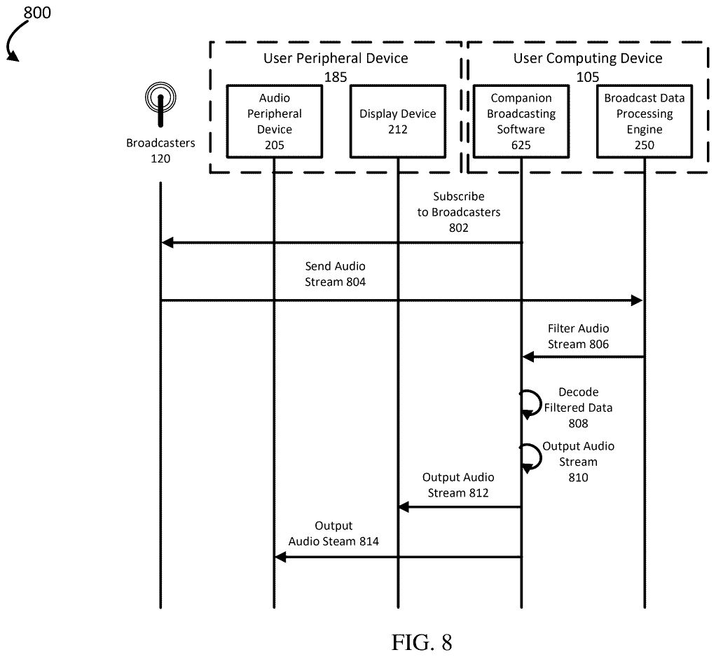

FIG. 8 is a flow diagram of an example process 800 for broadcasting audio streams to receiving devices, according to aspects of the disclosure.

According to line 802, the user computing device 105 subscribes to broadcasted streams of data, such as audio streams and/or data packets. For example, the companion broadcasting software 625 may detect available streams from broadcasters 120. The companion broadcasting software 625 may include a request display element 630, identifying the available streams and the option for a user to select whether to subscribe, or connect, to a given stream. The request display element 630 may, additionally, include requests for information associated with the stream.

As an example, if the system determines that the user computing device 105 is at a given point of interest, such as a fast food restaurant, the request display element 630 may request information about the user's order, such as their order number. The system may determine the location of the user computing device 105 based on the location associated with the broadcaster 120 which the user computing device 105 is subscribed to, a location sensor, e.g., a GPS sensor, or the like. The request for information associated with the subscribed stream allows for the system to filter the audio stream such that only announcements pertaining to the user computing device 105 and, therefore, the user are provided for output. Filtering the announcements increases the efficiency of the system by decreasing the amount of processing power. For example, by filtering the announcements, fewer announcements have to be processed by the user computing device 105, thereby saving computational resources.

As another example, the request display element 630 may request authorization to access one or more databases of the user computing device 105 to identify information associated with the stream. For example, after the request display element 630 receives authorization to access one or more databases of the user computing device 105, the system may determine the user has an upcoming flight based on a calendar event, a ticket stored in the digital wallet, an email, or the like.

In yet another example, the request display element 630 may seek confirmation of information identified from the one or more databases of the user computing device 105 that the system has received authorization to access.

According to line 804, the broadcasters may send, or transmit, the audio stream the user computing devices 105 implementing broadcast data processing engines, such as broadcast data processing engine 250. Typically, the audio streams are processed directly by the user peripheral device 185 after the user computing device 105 instructs it to subscribe to said stream. However, the user computing device 105 can be configured such that the user computing device 105 can receive and decode the broadcasted audio streams.

The broadcast data processing engine 250 can filter received data packets, according to line 806. As described in FIGS. 1-3, 6 and 7, a device broadcast filter 187 can be implemented to filter out streams, e.g., data packets and audio streams, according to different factors, such as user preference, whether the broadcasted audio stream is relevant to the user as determined based on additional information provided to the user, etc. For example, if the user computing device 105 and, therefore, the user associated with the user computing device 105, is at the airport waiting for their flight, the processing engine 250 can filter incoming audio streams to allow for only audio streams related to the identified flight. By filtering the data, the user computing device can provide a better experience to the user by reducing the amount of redundant information that would otherwise distract or annoy the user associated with the user computing device 105 and can also cause user computing device 105 and/or peripheral device 185 to process less data overall, which improves the computational efficiency of the user computing device at least through reduced power consumption and fewer processing cycles to process less data.

The companion broadcasting software 625 decodes the filtered data, according to line 808. Decoding the data can include generating corresponding display or output elements for display or output through a user interface of a computing device. For example, metadata in received filtered audio streams can be rendered for display as various different display elements, such as the elements shown and described with reference to FIGS. 1, 2, and 6. Audio, or speech, can be converted to text through speech-to-text technology, such as a machine learning model trained to generate text from input audio.

The decoded audio streams may be provided for output. According to line 810, the audio stream is provided for output via the companion broadcasting software 625 on the user computing device 105. This may include, for example, providing a visual transcription of the audio stream via broadcast display element 635, providing an output element, such as a visual, audible, or haptic notification associated with the audio stream, or the like. The visual notification may be shown via broadcast display element 635 or a user interface of the user computer device 105. The visual notification may include text, indicating that there has been an announcement relevant to the user, that the user's turn or order is coming up soon, or the like. The audible or haptic notification may be used to alert the user to listen to the announcements in the audio stream.

Continuing with the example of the user being at the fast food restaurant, if the user provided information related to their order, e.g., their pick-up ticket number or order number, the audio streams may be filtered such that only announcements related to the user's order are provided as an output element, such as a transcription or notification. In some examples, the output element may be an indication that there are “X” number of orders ahead of the user's order number, where “X” is a predetermined number. In some examples, the output element may be a haptic notification that the announcement included the user's order number. By providing the decoded audio streams for output as an output element, the audio streams broadcasted by the broadcasters are more accessible to users that may be audibly impaired. Further, by providing the decoded audio streams for output as an output element, the audio streams can be more accessible to all users, especially in loud or noisy locations, where overhead announcements are difficult to hear or understand.

Continuing with the example of the user having an upcoming flight, if the system configured authorization to access databases associated with the user computing device such that the user's flight information can be determined or if the user provided the flight information, the audio streams at the airport may be filtered such that only announcements related to the user's flight are provided as an output element.

According to line 812, the audio stream is provided for output via the display device 212 of the user peripheral device 185. Similar to providing the audio stream for output via the user computing device 105, providing the audio stream for output via the display device 212 can include providing a transcription of the audio stream, providing a visual notification associated with the audio stream, or the like.

According to line 814, the audio stream is provided for output via the audio peripheral device 205. Providing the audio stream for output via the audio peripheral device 205 can include, for example, providing an audible notification that a relevant announcement is being made, providing enhanced audio of the relevant announcement, or the like.

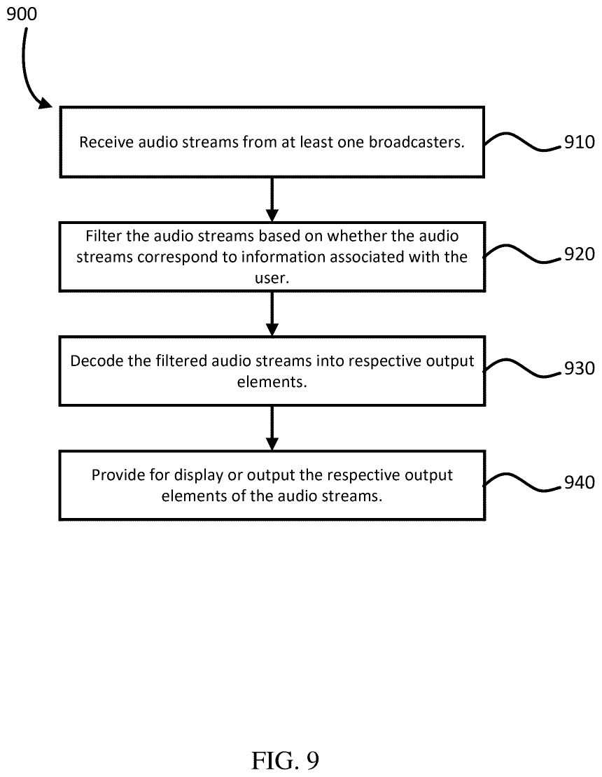

FIG. 9 is a flow diagram of an example process 900 for broadcasting data, including audio streams, to receive devices and providing the audio streams for output as an output element, according to aspects of the disclosure. The following operations do not have to be performed in the precise order described below. Rather, various operations can be handled in a different order or simultaneously, and operations may be added or omitted. The example process 900 can be performed on a system of one or more processors in one or more locations, such as the navigation system of FIG. 3.

The one or more processors receive audio streams from at least one broadcaster, according to block 910. The broadcasters are configured to broadcast data, such as audio streams and data packets. The broadcasters may be, for example, a broadcaster implementing Auracast™. The audio streams are typically provided to peripheral devices 185 for output as audio to a user. However, a user computing device 105 can be configured to receive and decode the audio streams. As described above with references to FIGS. 1 and 6, the one or more processors can be at least partially implemented in the user computing device 105 implementing companion broadcasting software 625. The companion broadcasting software 625 is configured to identify or prompt the user for information that would be used by a filter. The companion broadcasting software 625, additionally, configured to generate output elements for the audio streams.

The one or more processors filter the audio streams based on whether the audio streams correspond to information associated with the user, according to block 920. For example, the companion broadcasting software 625 includes a request display element 630. The request display element 630 may show one or more requests to the user via the user interface of the user computing device 105. The request can include options to subscribe to a stream from the broadcasters, a request for information associated with the subscribed audio stream, an authorization request to access one or more databases of the user computing device 105, or the like. The response to the request provides the companion broadcasting software 625 with the information associated with the user.

As an example, if the system determines that the user computing device 105 is at a movie theater, the request for information associated with the user may include, for example, which theater room the user will be sitting in, which movie they are seeing, or the like. The system may determine the location of the user based on the location of the broadcaster, location sensors, such as GPS, or the like.

The one or more processors decode the filtered audio streams into respective output elements, according to block 930. For example, the one or more processors can process the audio streams through speech-to-text technology to visually output the audio as text. For example, the audio processor 230 may process the audio streams to convert the audio to text.

The output elements include, for example, a transcription of the audio streams, a visual notification associated with the audio streams, a haptic notification associated with the audio streams, or an audible notification associated with the audio streams. Continuing with the movie theater example, the output element may be a transcription of the audio associated with the movie being played. In some examples, the output element is a notification to enter the theater as the movie will begin in “Y” minutes, where “Y” is a predetermined amount of time.

The one or more processors provide the respective output elements for display or output, according to block 940. For example, the one or more processors can update a display element, such as broadcast display element 635 or display device 212, to show the output element. In some examples, the one or more processors can output a haptic or audible notification. For example a user computing device 105 or peripheral device 185 with a display or speakers can output the visual or audible output element.

According to some examples, the one or more processors may be configured to generate the notification based on the information associated with the user and the decoded audio streams. As an example, if the user computing device is located at a place of interest, such as a point of interest that provides a number corresponding to an order, e.g., a restaurant, or a place in line, e.g., a deli counter at a food store, the notification may be generated using an artificial intelligence (“AI”) model. The point of interest may broadcast data, such as the order numbers, next number in line, etc. via broadcasters as part of their announcement systems. The broadcasts may be in the form of data packets and/or audio streams. The model may be trained to decode the announcements, either through metadata associated with the broadcasted data and/or the audio data from the audio stream. The model may receive, as input, other signals, such as location geolocation information of the user computing device. The request display element 630 may, when subscribing to the broadcaster, provide a request, or seek user input, accepting notifications for monitoring the queue at the point of interest. The model, based on the broadcast data, can track the queue of the point of interest and provide the user computing device with notifications when the order number, queue number, etc. is approaching and/or is the number being called.

In some examples, the model may be trained to parse the decoded audio data to become more intelligent over time, such that the model can combine the audio data with other information. In some examples, the user computing device may receive, as input, a request to provide notification related to the queue, transit schedules, transit arrivals and/or departures, etc. An example request may be to provide a notification when an announcement is made relating to a flight, e.g., air travel ticket, associated with the user computing device. Another example request may be to provide a notification when the number in the queue is “X” numbers before the number associated with the user computing device. In such an example, the model may parse the decoded audio data to determine when and what notification to provide the user computing device.

### Example Computing Environment

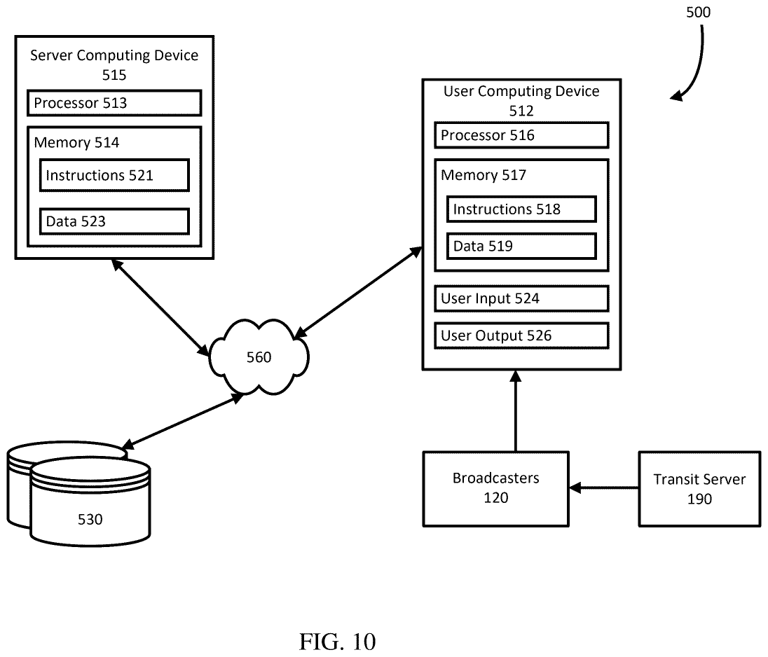

FIG. 10 is a block diagram of an example computing environment 500 for implementing the navigation system 100. The system 100 can be implemented on one or more devices having one or more processors in one or more locations, such as in server computing device 515. User computing device 512 and the server computing device 515 can be communicatively coupled to one or more storage devices 530 over a network 560. The storage device(s) 530 can be a combination of volatile and non-volatile memory and can be at the same or different physical locations than the computing devices 512, 515. For example, the storage device(s) 530 can include any type of non-transitory computer readable medium capable of storing information, such as a hard-drive, solid state drive, tape drive, optical storage, memory card, ROM, RAM, DVD, CD-ROM, write-capable, and read-only memories. The user computing device 512 may be compared with other user computing devices described herein, e.g., user computing device 105 and/or user peripheral device 185.

Aspects of the disclosure can be implemented in a computing system that includes a back-end component, e.g., as a data server, a middleware component, e.g., an application server, or a front-end component, e.g., user computing device 512 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients, e.g., user computing device 512 and servers, e.g., server computing device 515. The server computing device 515 can be part of one or more servers implementing the navigation platform 165. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

The server computing device 515 can include one or more processors 513 and memory 514. The memory 514 can store information accessible by the processor(s) 513, including instructions 521 that can be executed by the processor(s) 513. The memory 514 can also include data 523 that can be retrieved, manipulated, or stored by the processor(s) 513. The memory 514 can be a type of non-transitory computer readable medium capable of storing information accessible by the processor(s) 513, such as volatile and non-volatile memory. The processor(s) 513 can include one or more central processing units (CPUs), graphic processing units (GPUs), field-programmable gate arrays (FPGAs), and/or application-specific integrated circuits (ASICs), such as tensor processing units (TPUs).

The instructions 521 can include one or more instructions that when executed by the processor(s) 513, causes the one or more processors to perform actions defined by the instructions. The instructions 521 can be stored in object code format for direct processing by the processor(s) 513, or in other formats including interpretable scripts or collections of independent source code modules that are interpreted on demand or compiled in advance. The instructions 521 can include instructions for implementing at least part of the system 100 consistent with aspects of this disclosure. The system 100 can be executed using the processor(s) 513, and/or using other processors remotely located from the server computing device 515. In some examples, the server computing device 515 is configured to perform operations of both the transit server and the navigation platform 165.

The data 523 can be retrieved, stored, or modified by the processor(s) 513 in accordance with the instructions 521. The data 523 can be stored in computer registers, in a relational or non-relational database as a table having a plurality of different fields and records, or as JSON, YAML, proto, or XML documents. The data 523 can also be formatted in a computer-readable format such as, but not limited to, binary values, ASCII, or Unicode. Moreover, the data 523 can include information sufficient to identify relevant information, such as numbers, descriptive text, proprietary codes, pointers, references to data stored in other memories, including other network locations, or information that is used by a function to calculate relevant data.

The user computing device 512 can also be configured similar to the server computing device 515, with one or more processors 516, memory 517, instructions 518, and data 519. For example, the user computing device 512 can be a mobile device, a laptop, a desktop computer, a game console, etc. The user computing device 512 can also include a user output 526, and a user input 524. The user input 524 can include any appropriate mechanism or technique for receiving input from a user, including acoustic input; visual input; tactile input, including touch motion or gestures, or kinetic motion or gestures or orientation motion or gestures; auditory input, speech input, etc., Example devices for user input 524 can include a keyboard, mouse or other point device, mechanical actuators, soft actuators, touchscreens, microphones, and sensors.

The server computing device 515 can be configured to transmit data to the user computing device 512, and the user computing device 512 can be configured to display at least a portion of the received data on a display implemented as part of the user output 526. The user output 526 can also be used for displaying an interface between the user computing device 512 and the server computing device 515. The user output 526 can alternatively or additionally include one or more speakers, transducers or other audio outputs, a haptic interface or other tactile feedback that provides non-visual and non-audible information to the platform user of the user computing device 512.

Although FIG. 10 illustrates the processors 513, 516 and the memories 514, 517 as being within the computing devices 515, 512, components described in this specification, including the processors 513, 516 and the memories 514, 517 can include multiple processors and memories that can operate in different physical locations and not within the same computing device. For example, some of the instructions 521, 518 and the data 523, 519 can be stored on a removable SD card and others within a read-only computer chip. Some or all of the instructions and data can be stored in a location physically remote from, yet still accessible by, the processors 513, 516. Similarly, the processors 513, 516 can include a collection of processors that can perform concurrent and/or sequential operation. The computing devices 515, 512 can each include one or more internal clocks providing timing information, which can be used for time measurement for operations and programs run by the computing devices 515, 512.

The devices 512, 515 can be capable of direct and indirect communication over the network 560. The devices 515, 512 can set up listening sockets that may accept an initiating connection for sending and receiving information. The network 560 itself can include various configurations and protocols including the Internet, World Wide Web, intranets, virtual private networks, wide area networks, local networks, and private networks using communication protocols proprietary to one or more companies. The network 560 can support a variety of short-and long-range connections. The short-and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 560, in addition or alternatively, can also support wired connections between the devices 512, 515, including over various types of Ethernet connection.

Broadcasting broadcasters 120 can be configured to receive data from transit server 190, which may be over a connection similar to a connection over network 560. Given that the broadcaster may be in a location in which long-range communication may be difficult or impossible, the transit server 190 may be connected through a local area network, mesh network, or wired connection to one or more of the broadcasters 120.

Although a single server computing device 515, user computing device 512, and transit server 190 are shown in FIG. 10, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof. In some examples, user peripheral devices 185 with computational capabilities added, such as earbuds, may be a user computing device 512.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more engines or modules of computer program instructions encoded on one or more tangible non-transitory computer storage media for execution by, or to control the operation of, one or more data processing apparatus.

A computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus. A computer program may, but need not, correspond to a file in a file system. A computer program can be stored in a portion of a file that holds other programs or data, e.g., one or more scripts, in a single file, or in multiple coordinated files, e.g., files that store one or more engines, modules, sub-programs, or portions of code.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” can refer to a software-based system, subsystem, or process that is programmed to perform one or more specific functions. The engine can be implemented as one or more software modules or components or can be installed on one or more computers in one or more locations. A particular engine can have one or more processors or computing devices dedicated thereto, or multiple engines can be installed and running on the same processor or computing device. In some examples, an engine can be implemented as a specially configured circuit, while in other examples, an engine can be implemented in a combination of software and hardware.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers. While operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all examples, and it should be understood that the described program components and systems can be integrated together in one or more software or hardware-based devices or computer-readable media.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, desktop computer, a personal digital assistant (PDA), a mobile audio or video player, a game console, a tablet, a virtual-reality (VR) or augmented-reality (AR) device, a Global Positioning System (GPS), or a portable storage device, e.g., a universal serial bus (USB) flash drive, as examples. Examples of the computer or special purpose logic circuitry can include the user computing device 512, or the server computing device 515

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

1. A method, comprising:
identifying, by one or more processors, one or more instructions for a navigation route to a destination;
determining, by the one or more processors, a current instruction of the one or more instructions to disembark from or embark on a vehicle;
receiving, by the one or more processors, navigation data from one or more data broadcasters;
updating, by the one or more processors, at least the current instruction of the one or more instructions based on the received navigation data; and
providing for display or output, by the one or more processors, at least the updated current instruction.

2. The method of claim 1, wherein the navigation data comprises one or more navigation data packets, the method further comprising:
decoding, by the one or more processors, the one or more data navigation packets into respective display elements or audio output; and
providing for display or output, by the one or more processors, the respective display elements or audio output of the one or more navigation data packets.

3. The method of claim 1, further comprising:
maintaining, by the one or more processors, a current location of a computing device comprising at least one of the one or more processors; and
updating for output or display, by the one or more processors, the current location of the computing device using the navigation data.

4. The method of claim 1, wherein:
the one or more data broadcasters comprise one or both of a vehicle data broadcaster located on the vehicle and a transit location broadcaster located in a transit location through which a transit route for the vehicle passes through, and
the one or more data broadcasters are configured for wireless unidirectional data connection to the one or more processors.

5. The method of claim 4, further comprising receiving, by the one or more processors, the one or more instructions through a bidirectional data connection between the one or more processors and a network access point.

6. The method of claim 1, further comprising:
filtering, by the one or more processors, the navigation data received from the one or more data broadcasters based on whether the navigation data corresponds to one or both of the vehicle or a transit route for the vehicle.

7. The method of claim 1, further comprising:
filtering, by the one or more processors, the navigation data received from the one or more data broadcasters based on one or more received user preferences.

8. The method of claim 7, wherein:
the navigation data comprises one or more data advertisements for respective data streams broadcasted by the one or more data broadcasters to subscribed devices; and
the method further comprises subscribing, by the one or more processors, to one or more data streams advertised in the filtered navigation data.

9. The method of claim 8, wherein a data stream comprises one or both of:
data corresponding to one or both of the vehicle or the transit route for the vehicle; and
audio data corresponding to one or both of the vehicle or the transit route for the vehicle.

10. The method of claim 9, further comprising:
receiving, by the one or more processors, the audio data; and
outputting, by one or more speakers communicatively coupled to the one or more processors, the audio data.

11. The method of claim 10, further comprising:
detecting, by the one or more processors, audio currently being output by the one or more speakers; and
causing, by the one or more processors, the audio currently being output to be paused or reduced in volume, prior to outputting the audio data.

12. The method of claim 9, further comprising:
automatically subscribing, by the one or more processors, to at least one of the one or more data streams when the one or more processors are in broadcasting range of at least one of the one or more data broadcasters.

13. The method of claim 1, wherein when at least one of the one or more data broadcasters are located inside the vehicle, the method further comprises:
determining a location of the vehicle and the at least one of the one or more data broadcasters; and
determining, based on the vehicle and the at least one of the one or more data broadcasters, a location of a user computing device.

14. The method of claim 1, wherein in receiving the navigation data further comprising receiving, by the one or more processors, metadata associated with the one or more data broadcasters, wherein:
the metadata identifies the respective data broadcaster, and
the navigation data is part of the metadata.

15. The method of claim 1, wherein receiving the navigation data further comprises receiving, by the one or more processors, a data stream and an audio stream, wherein the navigation data is part of the data stream.

16. The method of claim 1, further comprising:
identifying, by the one or more processors, one or more keywords within broadcast data received from the one or more data broadcasters; and
determining, by the one or more processors, based on the one or more keywords, a current location of a computing device comprising at least one of the one or more processors.

17. The method of claim 1, further comprising:
receiving, by the one or more processors, broadcast data from the one or more data broadcasters, wherein the broadcast data comprises the navigation data and at least one of the vehicle speed, heading of the vehicle, or a distance to or from a stop; and
updating, by the or more processors based on the broadcast data, a current location of a computing device comprising at least one of the one or more processors.

18. The method of claim 1, further comprising:
receiving, by the one or more processors, broadcast data from the one or more data broadcasters, wherein:
the broadcast data comprises the navigation data and audio data,
the audio data comprises labels;
determining, by the one or more processor based on the labels, to trigger a peripheral device to listen to an audio stream associated with the audio data; and
transmitting, by the one or more processors to the peripheral device, instructions to listen to the audio stream.

19. A system comprising:
one or more processors; and
one or more storage devices coupled to the one or more processors and storing instructions that, when executed by the one or more processors, cause the one or more processors to perform operations comprising:
identifying one or more instructions for a navigation route to a destination;
determining a current instruction of the one or more instructions to disembark from or embark on a vehicle;
receiving navigation data from one or more data broadcasters;
updating at least the current instruction of the one or more instructions based on the received navigation data; and
providing for display or output at least the updated current instruction.

20. One or more non-transitory computer-readable media for storing instructions that, when executed by one or more processors, cause the one or more processors to perform operations comprising:
identifying one or more instructions for a navigation route to a destination;
determining a current instruction of the one or more instructions to disembark from or embark on a vehicle;
receiving navigation data from one or more data broadcasters;
updating at least the current instruction of the one or more instructions based on the received navigation data; and
providing for display or output at least the updated current instruction.
